(19) United States
(12) Patent Application Publication
(10) Pub. No.: US 2022/0162466 A1
(43) Pub. Date: May 26, 2022

(54) NAIL PRINTING

(71) Applicant: Hewlett-Packard Development Company, L.P., Spring, TX (US)

(72) Inventors: Douglas Knight, San Diego, CA (US); Peter C. ZAHROBSKY, San Diego, CA (US)

(73) Assignee: Hewlett-Packard Development Company, L.P., Spring, TX (US)

(21) Appl. No.: 17/437,092

(22) PCT Filed: Oct. 1, 2019
(86) PCT No.: PCT/US2019/054136

§ 371 Date: Sep. 8, 2021

(51) Int. Cl. C09D 11/322; A45D 29/00

(52) U.S. Cl. CPC C09D 11/322; A45D 2029/005; A45D 29/00

(57) ABSTRACT

A fluid set for nail printing can include a primer composition including from 40 wt % to 90 wt % primer vehicle selected from an aqueous primer vehicle, an alcohol-based primer vehicle, or a combination thereof, and from 5 wt % to 50 wt % soluble polymer binder that is soluble in the primer vehicle. The fluid set can also include an aqueous inkjet ink composition including an ink vehicle and a colorant. The fluid set can also include a clear coat composition including a water-insoluble polymer.

### BACKGROUND

Nail art is traditionally applied manually, occupying a considerable amount of time and skill on the part of the applicator. Self-application is popular and typically includes only one or perhaps two colors due to the difficulty that most users have using their non-dominant hand during application. Furthermore, visiting a beautician/nail technician for applying nail art can be expensive. In recent years, nail art printing kiosks have been becoming somewhat popular, and are often installed in public places, such as shopping centers or nail salons which allow a user to interact with a computing device enclosed in the kiosk. These types of devices typically involve scanning hand positioning to locate the position of the user's finger nail and/or printer components to clamp the user's finger into a known position. Such components make these types of devices costly to own, and due to human error and positioning, may not apply to the full fingernail and only the fingernail.

### BRIEF DESCRIPTION OF DRAWINGS

FIGS. 1A-1B are cross-sectional views illustrating example composition layers formed from a fluid set for nail printing in accordance with the present disclosure;

FIGS. 2A-2F schematically depict example nail printing systems and methods in accordance with the present disclosure;

FIG. 3 schematically shows an example system for nail printing in accordance with the present disclosure; and

FIG. 4 depicts an example method of nail printing in accordance with the present disclosure.

### DETAILED DESCRIPTION

Nail art, e.g., application of printed designs to a fingernail(s) or toenail(s), can be implemented in accordance with the present disclosure using a fluid set for printing a nail, as well as in accordance with a method and/or a system for printing on a nail. In one example of the present disclosure, fluid set for nail printing includes a primer composition, an aqueous inkjet ink composition, and a clear coat composition. The primer composition includes from 40 wt % to 90 wt % a primer vehicle selected from an aqueous primer vehicle, an alcohol-based primer vehicle, or a combination thereof. The primer composition also includes from 5 wt % to 50 wt % soluble polymer binder that is soluble in the primer vehicle. The aqueous inkjet ink composition includes an ink vehicle and a colorant. The clear coat composition includes a water-insoluble polymer. In one specific example, the primer composition can further include from 0.1 wt % to 18 wt % pigment including white metal oxide pigment. In another example, the soluble polymer binder can be a cationic water-soluble polymer binder. In another example, the soluble polymer binder can be a polyvinyl alcohol, a polyacrylic acid, a polyvinyl pyrrolidone, or a mixture thereof. In another example, the primer composition can include a latex polymer, in addition to the primer vehicle-soluble polymer, such as a polyvinyl acetate polymer, a polyvinyl butyral polymer, a hydrophobic-modified ethoxylated urethane polymer, a cellulosic polymer, or a combination thereof. The colorant used in the inkjet ink composition can include anionic dye that is interactive with the soluble polymer binder of the primer composition, for example. In further detail, the primer vehicle can include water and an organic co-solvent selected from methanol, ethanol, isopropyl alcohol, acetone, or a combination thereof. In another example, the clear coat composition can be in the form of an ultraviolet curable gel, or the clear coat composition comprises nitrocellulose polymer.

In another example, a method of nail printing includes applying a primer composition to a nail and to a margin of skin adjacent to the nail. The primer composition in this example includes a primer vehicle selected from an aqueous primer vehicle, an alcohol-based primer vehicle, or a combination thereof, as well as a soluble polymer binder that is soluble in the primer vehicle. The method also includes inkjet printing an aqueous ink composition on the primer composition, including over the nail as well as over a portion of the margin of skin. The method in this example also includes applying a clear coat composition over the ink composition applied to the nail, but not to the margin of skin. Thus, in accordance with this method, the primer composition and the ink composition applied to the margin of skin surrounding the nail is washable to remove these layers after the clear coat composition has sufficiently dried, thus avoiding removal of the ink composition applied to the nail. In one more specific example, the method can further include applying the clear coat composition to the nail prior to application of the primer composition to protect the nail from staining. In another example, the method can further include applying the primer composition and applying the clear coat composition where both are applied independently using an analog applicator. In another example, the soluble polymer binder of the primer composition swells and entraps the colorant when the aqueous inkjet ink composition is applied to the primer composition on the nail and on the portion of the margin of skin. In another example, the soluble polymer binder of the primer composition crashes with the colorant when the aqueous inkjet ink composition is applied to the primer composition on the nail and on the portion of the margin of skin.

In another example, a system for printing on a nail includes a primer composition, including a primer vehicle selected from an aqueous primer vehicle, an alcohol-based primer vehicle, or a combination thereof. The primer composition further includes a soluble polymer binder that is soluble in the primer vehicle and a first analog applicator to apply the primer composition to a nail and a margin of skin surrounding the nail. The system further includes an aqueous inkjet ink composition including an ink vehicle and a colorant, as well as a printer including an inkjet printhead directed or directable to print the aqueous inkjet ink composition on the nail and a portion of the margin of skin when a digit is positioned to receive the aqueous inkjet ink composition. The system also includes a clear coat composition including a water-insoluble polymer and a second analog applicator to apply the clear coat composition on the nail but not to the margin of skin. In one more specific example, the printer can include a digit positioner to assist with positioning a nail at a specified location associated with the printer in order to receive the aqueous inkjet ink composition at the nail and the portion of the margin of skin.

It is noted that when discussing the fluid set for nail printing, the method of nail printing, and the system for nail printing, these discussions can be considered applicable to other examples whether or not they are explicitly discussed in the context of that example. Thus, for example, in discussing a colorant, such as a dye, related to the ink composition, such disclosure is also relevant to and directly supported in context of the printing system or the method of nail printing, and vice versa.

Thus, the present technology can include, for example, applying a primer composition over a nail and to a margin of skin surrounding the nail using a brush applicator. As mentioned, the primer composition may include a base of water, alcohol, or both, as well as a water- and/or alcohol-soluble polymer binder. The term “alcohol-based” refers to primer vehicles where the predominant solvent component is one or more of C1 to C4 alcohol. Water may be included in alcohol-based primer vehicles, or in some examples, they may be devoid of water. “Aqueous” primer vehicles include a predominant amount of water compared to other primer vehicle components, and may include alcohols or other organic cosolvents as well. In some examples, aqueous primer vehicles may be devoid of organic co-solvent.

In some instances, the primer composition may include a pigment or filler, or other material to assist the primer composition in being opaque and of a color (or white) acceptable to receive the ink composition thereof with good image quality. Other components can likewise be included in the primer composition, such as latex polymer, thickener, dispersant, wetting aid, etc. After the primer composition is applied, the ink composition may be printed over the primer including overprinting onto the skin surrounding the fingernail that is also coated with the primer composition. An inkjet printer can be used that may include a digit positioner also referred to as a finger positioning device or jig, but which does not have to be particularly precise due to the allowance for overprinting on the skin coated with the primer composition. After printing, a clear coat is applied only over the ink composition that is applied to the nail. The clear coat is not water-soluble, and for example, may be an off the shelf clear or semi-clear nail polish, or other similar coating composition. After the clear coat is sufficiently dry, the finger may be washed with water, and in some cases with the assistance of an organic solvent and/or surfactant (soap) to remove the primer and overprinted ink composition that is not protected by the clear coat composition, leaving the ink composition covering nail protected by the clear coat composition. In some more specific examples, the nail can be coated with a protective coating on the nail to protect the nail from staining due to the printing process, though this layer may or may not be used in various circumstances.

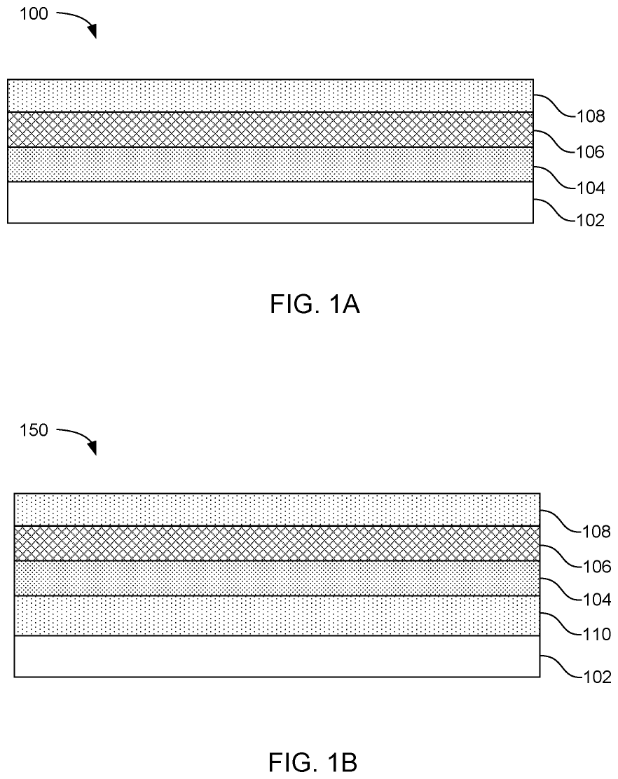

In accordance with a more specific example, FIG. 1A illustrates a cross section of layers 100 formed from the fluid set that can be used to cover a nail 102. The fluid set can include compositions, which can be applied as “layers.” Thus, the compositions described herein can be referred to herein as compositions or as layers, with the difference being that when applied as a layer, drying can occur to the composition for application of another layer of a composition thereon. In some examples the compositions can be applied as layers in a wet-on-wet process, or as a wet-on-dry process. Thus, as shown in FIG. 1A, the first composition layer applied to the nail can be from a primer composition 104. The primer composition can also be applied to the skin surrounding the nail, and can be applied as an analog fluid, such as by using an analog applicator. For example, the primer composition may be applied to a margin of skin extending beyond the borders of the nail. An “analog” composition or application using an “analog” applicator indicates that the composition can be applied using any of a number of coating devices, but are not typically applied using digitally controlled application processes with pixel level control.

The soluble polymer binder included in the primer composition can be, for example, a water-soluble polymer binder, an alcohol-soluble polymer binder, etc. Essentially the soluble polymer binder is soluble in whatever type of primer vehicle is used. However, in one example, the soluble polymer binder can be a cationic water-soluble binder. In other examples, the soluble polymer binder can include a polyvinyl alcohol (PVOH), a polyacrylic acid, a polyvinyl pyrrolidone (PVP), or a mixture thereof.

The weight average molecular weight of the soluble polymer binder can range from 100 Mw to 100,000 Mw, from 1,000 Mw to 40,000 Mw, or from 3,000 Mw to 20,000 Mw, for example. The soluble polymer binder can be selected to provide multiple characteristics including a suspension matrix for the pigment or other solids, if present, a rheology and/or leveling agent promoting good coating properties when applying wet to the nail 102, good adhesion to a surface of the nail, good absorbance of the subsequently applied ink composition 106, good skin barrier to reduce or prevent ink composition staining, good dry wettability by and adhesion to clear overcoat when applied, washability from the skin with water or with water and mild soap or organic solvent, etc. In one example, there can be multiple soluble polymer binders present. For example, there may be a high molecular weight polyvinyl alcohol binder and a low molecular weight polymer binder present in the primer composition. “High molecular weight” can be defined as having a weight average molecular weight form 10,000 Mw to 100,000 Mw, from 10,000 Mw to 40,000 Mw, or from 12,000 Mw to 25,000 Mw, for example. “Low molecular weight” can be defined as having a weight average molecular weight from 100 Mw to less than 10,000 Mw, from 1,000 Mw to 5,000 Mw, or from 1,000 Mw to 3,000 Mw, for example.

In some examples, there may additionally be polymer present (other than the soluble polymer binder, e.g., polymer that is soluble in primer vehicle), such as polymer that is insoluble in the primer vehicle. Examples may include any of a number of latex polymers, such as polyvinyl acetate (PVAc) polymer, a polyvinyl butyral (PVB) polymer, a hydrophobic-modified ethoxylated urethane polymer, a cellulosic polymer, or a combination thereof. The latex polymer can be an emulsion of the solubilized soluble polymer binder in the binder vehicle, for example. The latex polymer can be useful for providing some of the same characteristics imparted by the soluble polymer binders, except for perhaps water wash off. Such latex polymer, if included, can provide additional protection against removal, e.g., abrasion resistance, durability, adhesion, stain resistance, etc. When adding latex polymer in addition to the soluble polymer binder included in the primer composition, tradeoff considerations related to image quality performance, durability, washability for removal from the skin, etc., can be considered. If a latex polymer is included in addition to the soluble polymer binder, a weight ratio of soluble polymer binder to latex polymer can be from 10:1 to 1:2, from 5:1 to 1:1, or from 3:1 to 1:1, for example.

There may be other components in the primer composition that may be included as well, such as thickener, pigment such as a white pigment, e.g., metal oxide particles, dispersant, wetting aid, surfactant, organic co-solvent, etc. Thickener, if included, can be selected to provide static high viscosity to prevent pigment settling and/or for shear-thinning low viscosity during application to the nail 102. Example thickener that can be used is HEUR or Cellulosics. Whether or not a thickener is used, the viscosity of the primer composition formulated for use can be from 5 centipoise (cP) to 500 cP, or from 5 cP to 200 cP, for example. As the primer composition of the present disclosure may typically be applied using an analog application process, in some examples, viscosities higher than that typically used for thermal inkjet printing can be used, e.g., from 20 cP to 500 cP, so upon application, the primer composition is not particularly runny. Viscosities outside of this range can likewise be used. Viscosity can be determined or measured with a Brookfield Viscometer with appropriate spindle for estimated viscosity range of the fluid (to be verified using the Viscometer. For example, for fluids within the viscosity ranges, the LV-3 spindle can be used and the viscosity measurement taken at 23° C. (held in temp controlled water bath).

In some other examples, the primer composition 104 can be formulated to include a pigment, which may provide a base color (or white) that is desired for printing the inkjet ink composition thereon. The pigment, for example, can be a white pigment to provide clean palette for subsequent application of ink composition thereto. In one example, if a white pigment is selected for use, pigment may be a white metal oxide pigment. Example white metal oxide pigments that can be selected for use include titanium dioxide, e.g., rutile titanium dioxide or anatase titanium dioxide, zinc oxide, zirconium dioxide, etc. These pigments may be coated with aluminum oxide (alumina) or silicon dioxide (silica) silica dioxide, for example. These particles can have a refractive index ranging from 1.8 to 2.8, or from 2.2 to 2.8, e.g., zinc oxide (about 2.4), titanium dioxide (about 2.5 to 2.7), or zirconium dioxide (about 2.4).

If white pigment is included in the primer compositions, dispersion of metal oxide particles can be prepared via milling or dispersing metal oxide powder in water in the presence of dispersants, for example. For example, the metal oxide dispersion may be prepared by milling inorganic white metal oxide particles having relatively large particle size (in the micron range) in the presence of polymeric or oligomeric dispersants until a target particle size is achieved. However, since these primer compositions may be applied as analog coating compositions, the particle size of the white pigments may be useable within a relatively wide range of particle sizes. The white metal oxide particles, for example, may have a D50 particle size from 100 nm to 5 μm, from 200 nm to 1 μm, or from 300 nm to 750 nm, for example, whether or not the particles are milled or not. If milling is used, the milling equipment that can be used may be a bead mill, which is an example of a wet grinding machine capable of using very fine beads having diameters of less than 1.0 mm (and, generally, less than 0.3 mm) as the grinding medium, for example, such as UltraApex™ Bead Mills from Kotobuki Industries Co. Ltd. (Japan). The milling duration, rotor speed, and/or temperature may be adjusted to achieve the dispersion particle size targeted.

“D50” particle size is defined as the particle size at which about half of the particles are larger than the D50 particle size and about half of the other particles are smaller than the D50 particle size (by weight based on the metal particle content of the particulate build material). As used herein, particle size, regardless of the type of pigment or polymer, can be based on volume of the particle size normalized to a spherical shape for diameter measurement, for example. Particle size can be measured using a particle analyzer such as the Mastersizer™ 3000 available from Malvern Panalytical, for example, and/or can be verified using a scanning electron microscope (SEM). A particle analyzer can measure particle size using laser diffraction. A laser beam can pass through a sample of particles and the angular variation in intensity of light scattered by the particles can be measured. Larger particles scatter light at smaller angles, while small particles scatter light at larger angles. The particle analyzer can then analyze the angular scattering data to calculate the size of the particles using the Mie theory of light scattering. The particle size can be reported as a volume equivalent sphere diameter. D50 particle size, particularly with respect to the metal oxide particles, can likewise be taken using a disc centrifuge since the metal oxides are denser than water. Once the primer compositions are homogeneously mixed, they can be dilute din water for higher sensitivity analytics. Gross particle size screening can be done with Hegman gauges.

In further detail, in some examples, there may be colorless (or pale) metal oxide particles or other colorless (or pale) polymer particles added to provide spacing between the white metal oxide particles, which may enhance the opacity provided by the white metal oxide particles. The term “colorless” refers to particles that exhibit no color or if there is color, it is very light such that it will not influence the whiteness provided by the white metal oxide in a negative manner (becomes less white), but rather can influence the whiteness in a positive manner (provides spacing to increase whiteness or white opacity). For example, because of the relatively high refractive index of the white metal oxide particles and the relatively low refractive index optical spacing provided by certain particles, the opacity of the primer composition may be boosted. Thus, particles such as certain amphoteric alumina particles, silica particles, latex particles, etc., may be used to enhance opacity, for example, by reducing a crowding effect of tightly-packed high refractive index (n) particles with little or no spacing, which can decrease light scattering and increase transparency of the white primer composition.

Furthermore, certain pigments may be selected for use for purposes other than enhancing opacity, or in addition to enhancing opacity of the primer composition, such as to include cheaper ingredients, enhance or modify adhesion performance of ink composition and/or clear overcoat, enhance the dispersability of the white pigment or other solids, etc. Inorganic pigments that can be used may include fumed silica, boehmite alumina, calcium carbonate, clay, etc. Combinations of white metal oxide particles can also be used. In one example, sparkle and glow can be added to the background of nail art by adding metallic, pearlescent, and/or luminescent cosmetic colorants to the primer composition. “Pearlescent” may be defined as having any of the following visual characteristics pearlescent, iridescent, opalescent, luster, shimmer, etc. Pearlescent effect can be attained by adding mica. Examples of materials that can be used include ColorGlo™ series pigments by IFC Solutions. “Metallic” effect can be attained by adding mineral particles, mica particles, or other particles that may provide a metallic sheen or sparkle. For example, Reflecks™ Timica™, and Chione™ series pigments from BASF can be used. “Luminescent” effect can be attained by adding fluorescent colorant blends, such as available as DermaGlo™ series pigments from Dayglo. Thus, when the ink composition used thereon is a dye-based ink, for example, as these types of ink compositions may be formulated to be somewhat translucent, these effects may show through printed areas to create a visual sparkle of sorts that shows through the printed ink composition layer. It should be appreciated that most of the sparkle and glow colorants will add some color tint to the background, so the user may consider the relative effect provided by such primer compositions compared to maintaining accurate color of the print as seen on white background, for example.

Regardless of the choice of pigment(s), if included, a total pigment content in the primer composition can be from 0.1 wt % to 18 wt %, from 2 wt % to 18 wt %, from 4 wt % to 15 wt %, or from 4 wt % to 12 wt % of the primer composition. The pigment can be selected to provide multiple characteristics including dispersion stability in fluid, shear-thinning rheology control for brush application, white color background or to provide high L* values for accurate ink composition color and larger color gamut, good absorbance or ink composition and/or clear overcoat, etc.

When using pigments or other solids in the primer compositions, dispersants and/or wetting aids can be used to stabilize the solids, e.g., pigment(s), such as by preventing agglomeration in fluid and to improve surface wetting and leveling during application to the nail. Dispersants can be polymeric dispersants that become associated with the surface of the pigments. For example, pigment(s) can be dispersed by a dispersant that is adsorbed or ionically attracted to a surface of the pigment, or alternatively, can be covalently attached to a surface of the pigment as a self-dispersed pigment. In one example, the dispersant can be an acrylic dispersant, such as a styrene (meth)acrylate dispersant, or other dispersant suitable for keeping the pigment dispersed in the primer vehicle. Other types of dispersants can likewise be used. However, since the present primer compositions may be applied as an analog coating, a wider variety of dispersion components and/or methodologies may be used compared to those used typically in thermal inkjet ink compositions.

In some examples, in addition to the base solvent used, e.g., water and/or alcohol, other co-solvents can be selected for use for any of a variety of purposes, such as to reduce surface tension of the composition, to enhance surface wetting and leveling during application, to enhance or otherwise modulate drying after application to the nail and surrounding skin surface, etc. In an aqueous system, co-solvents can be, for example, methanol, ethanol, propanol, e.g., isopropyl alcohol (IPA), acetone, etc. In alcohol-based primer compositions, a mixture of alcohols can be used, or other solvents can be added, such as acetone. Some alcohol primer vehicles may be alcohol-based but may still include a smaller amount of water. In one example, the primer vehicle can include water and an organic co-solvent selected from methanol, ethanol, isopropyl alcohol, acetone, or a combination thereof. It should be appreciated that when selecting dispersing and wetting agents as well as co-solvents, care can be taken to balance the solvent level between acceptable drying time benefit related to the printing properties, while keeping in mind considerations related to avoiding unhealthy drying out of the nail.

Table 1 demonstrates example ranges and components of primer compositions that may be prepared in accordance with the present disclosure. These are provided by example and should not be considered limiting outside of the limitations found in the claims.

TABLE 1
Example Primer Compositions

| | | Percentage |
|---|---|---|
| Component | Examples | Weight (Wt %) |
| Primer Vehicle Base* | Water and/or Alcohol | 40-90 |
| | (C1-C4 alcohol) | |
| Water-Soluble Binders | PVOH; PVP; | 5-25 |
| | Polyacrylic Acid | |
| Latex Polymers | PVAc; PVB; | 0.1 to 15 |
| | Hydrophobic-modified | (if present) |
| | Ethoxylated Urethane; | |
| | Cellulosic | |
| Thickener | Nonionic polyurethane, | 0.1 to 5 |
| | e.g., HEUR; Cellulosic | (if present) |
| Dispersed White Pigment** | TiO₂; ZnO; ZrO₂ | 0.1-18 |
| | | (if included) |

*Other organic co-solvents and/or additives may also be present for modulating dry time, wetting properties, etc., e.g., surfactant, acetone; etc.
**Other pigment(s) may also be included that may or may not be white pigment, such as alumina, e.g., boehmite, amphoteric alumina; silica; calcium carbonate; etc., as described in greater detail herein.

After application of the primer composition 104 to the nail 102 surface, an aqueous ink composition 106 can be applied thereon. The aqueous inkjet ink composition can include an ink vehicle and a colorant and can be formulated to be applied using an inkjet printer. The aqueous inkjet ink composition can thus form an ink composition layer over the primer composition, which is in turn applied over the nail, and over a portion of the skin immediately adjacent to the nail, for example. This aqueous ink composition application may be described herein as overprinting the nail, though it is also overprinting the primer composition that is on the nail. In one example, the colorant of the aqueous inkjet ink composition can include an anionic dye that may be interactive with the soluble polymer binder of the primer composition. The term “interactive” can be defined as capable of chemically reacting or crashing with the soluble polymer binder or can be a physical interaction that may occur due to the ink composition absorbing or swelling relative to the soluble polymer binder.

Generally, the colorant discussed herein can include a pigment and/or dye. As used herein, “dye” refers to compounds or molecules that impart color to the ink vehicle. As such, dye includes molecules and compounds that reflect and those that absorb certain wavelengths of visible light. Generally, dyes are water-soluble, but not always. Furthermore, as used herein, “pigment” generally includes pigment colorants, magnetic particles, aluminas, silicas, and/or other ceramics, organo-metallics or other opaque particles. In one example, the colorant can be a dye. In another example, the colorant can be present in the aqueous inkjet ink composition 106 in an amount ranging from 0.1 wt % to 10 wt % based on the weight of the inkjet ink composition as a whole. Typically, colorant is shipped in a liquid vehicle of its own as a dispersion, and thus, the contents of the dispersion can be formulated into the final inkjet ink composition. However, it is noted that the weight percentage of the colorant is based on the colorant per se, and does not include the other liquid components that are used to dispend or dissolve the colorant for shipment or storage, etc.

Dyes selected for use can be nonionic, cationic, anionic, or a mixture of nonionic, cationic, and/or anionic dyes. Specific examples of dyes that can be used include, but are not limited to, Sulforhodamine B, Acid Blue 113, Acid Blue 29, Acid Red 4, Rose Bengal, Acid Yellow 17, Acid Yellow 29, Acid Yellow 42, Acridine Yellow G, Acid Yellow 23, Acid Blue 9, Nitro Blue Tetrazolium Chloride Monohydrate or Nitro BT, Rhodamine 6G, Rhodamine 123, Rhodamine B, Rhodamine B Isocyanate, Safranine O, Azure B, and Azure B Eosinate, which are available from Sigma-Aldrich Chemical Company (St. Louis, Mo.). Examples of anionic, water-soluble dyes include, but are not limited to, Direct Yellow 132, Direct Blue 199, Magenta 377 (available from Ilford AG, Switzerland), alone or together with Acid Red 52. Examples of water-insoluble dyes include azo, xanthene, methine, polymethine, and anthraquinone dyes. Specific examples of water-insoluble dyes include Orasol® Blue GN, Orasol® Pink, and Orasol® Yellow dyes available from Ciba-Geigy Corp. Black dyes may include, but are not limited to, Direct Black 154, Direct Black 168, Fast Black 2, Direct Black 171, Direct Black 19, Acid Black 1, Acid Black 191, Mobay Black SP, and Acid Black 2.

Pigments, on the other hand, can be in colorant particles that are dispersed by a dispersant or dispersing compound that is either associated with the surface of the pigment, or attached to a surface of the pigment. Thus, the pigments can be self-dispersed (dispersant polymer, oligomer, or small molecule covalently attached to a surface of the pigment); or can be dispersed with a separate dispersant polymer or oligomer, for example. Suitable pigments include, but are not limited to, the following pigments available from BASF: Paliogen® Orange, Heliogen® Blue L 6901F, Heliogen® Blue NBD 7010, Heliogen® Blue K 7090, Heliogen® Blue L 7101F, Paliogen® Blue L 6470, Heliogen® Green K 8683, and Heliogen® Green L 9140. The following black pigments are available from Cabot: Monarch® 1400, Monarch® 1300, Monarch® 1100, Monarch® 1000, Monarch® 900, Monarch® 880, Monarch® 800, and Monarch® 700. The following pigments are available from CIBA: Chromophtal® Yellow 3G, Chromophtal® Yellow GR, Chromophtal® Yellow 8G, Igrazin® Yellow SGT, Igralite® Rubine 4BL, Monastral® Magenta, Monastral® Scarlet, Monastral® Violet R, Monastral® Red B, and Monastral® Violet Maroon B. The following pigments are available from Degussa: Printex® U, Printex® V, Printex® 140U, Printex® 140V, Color Black FW 200, Color Black FW 2, Color Black FW 2V, Color Black FW 1, Color Black FW 18, Color Black S 160, Color Black S 170, Special Black 6, Special Black 5, Special Black 4A, and Special Black 4. The following pigment is available from DuPont: Tipure® R-101. The following pigments are available from Heubach: Dalamar® Yellow YT-858-D and Heucophthal Blue G XBT-583D. The following pigments are available from Clariant: Permanent Yellow GR, Permanent Yellow G, Permanent Yellow DHG, Permanent Yellow NCG-71, Permanent Yellow GG, Hansa Yellow RA, Hansa Brilliant Yellow 5GX-02, Hansa Yellow-X, Novoperm® Yellow HR, Novoperm® Yellow FGL, Hansa Brilliant Yellow 10GX, Permanent Yellow G3R-01, Hostaperm® Yellow H4G, Hostaperm® Yellow H3G, Hostaperm® Orange GR, Hostaperm® Scarlet GO, and Permanent Rubine F6B. The following pigments are available from Mobay: Quindo® Magenta, Indofast® Brilliant Scarlet, Quindo® Red R6700, Quindo® Red R6713, and Indofast® Violet. The following pigments are available from Sun Chemical: L74-1357 Yellow, L75-1331 Yellow, and L75-2577 Yellow. The following pigments are available from Columbian: Raven® 7000, Raven® 5750, Raven® 5250, Raven® 5000, and Raven® 3500. The following pigment is available from Sun Chemical: LHD9303 Black. Any other pigment and/or dye can be used that is useful in modifying the color of the UV curable ink. Additionally, the colorant can include a white pigment such as titanium dioxide, or other inorganic pigments such as zinc oxide and iron oxide.

In one example, the aqueous inkjet ink composition 106 can further include a surfactant. There are several surfactants that can be selected for use in the inkjet ink compositions of the present disclosure. Non-limiting examples of suitable surfactants include nonionic surfactant, cationic surfactant, and combinations thereof. In one example, the surfactant can be a nonionic surfactant. Several commercially available nonionic surfactants that can be used in the formulation of the pre-treatment composition include ethoxylated alcohols such as those from the Tergitol® series (e.g., Tergitol® 15S30, or Tergitol® 15S9), manufactured by Dow Chemical; surfactants from the Surfynom series (e.g. Surfynol® 104, Surfynol® 440 and Surfynol® 465), and Dynol™ series (e.g. Dynol™ 607 and Dynol™ 604) manufactured by Air Products and Chemicals, Inc.; fluorinated surfactants, such as those from the Zonyl® family (e.g., Zonyl® FSO and Zonyl® FSN surfactants), manufactured by E.I. DuPont de Nemours and Company; Alkoxylated surfactant such as Tego Wet 510 manufactured from Evonik; fluorinated PolyFoe nonionic surfactants (e.g., PF159 nonionic surfactants), manufactured by Omnova; or combinations thereof. Suitable cationic surfactants that may be used in the pre-treatment composition include long chain amines and/or their salts, acrylated diamines, polyamines and/or their salts, quaternary ammonium salts, polyoxyethylenated long-chain amines, quaternized polyoxyethylenated long-chain amines, and/or combinations thereof. One surfactant that can be used is an acetylenic diol nonionic surfactant. An example of an acetylenic diol nonionic surfactant is from the family of Surfynol® surfactants, such as Surfynol® 104 (2,4,7,9-tetramethyl-5-decyne-4,7-diol) or other similar surfactants. Another surfactant that can be used includes polyoxyethylene glycol ether, including those having the base structure, as follows: CH₃(CH₂)ₙ(CH₂CH₂O)ₘH, where m can be from 2 to 100, but is typically from about 2 to about 20; and n can be from about 8 to 20. Examples of such surfactants or similar surfactants that can be used include Brij® S, Brij® 0, Brij® C, and Brij® L type surfactants. Synperonic surfactants can also be used. Specific examples include Brij® S10, Brij® S5, Brij®, S15, Brij® S20, Brij® S2/93, Brij® S7, Brij® 98/O20, Brij® O10, Brij® O2, Brij®, O3, Brij® O5, Brij® C2, Brij® C7, Brij® C10, Brij®, C20, Brij® L4/30, Brij® L9, Brij® L15, Synperonic® 91-2.5, Synperonic® 91-2.5, or Synperonic® 91-10, to name a few. In yet another alternative example, perfluoropolyethers can be included. Some examples can include a primary alcohol or diol, such as Fluorolink composition D (HOCH₂CF₂O(CF₂CF₂O)ₚ(CF₂O)_{q}CF₂CH₂OH); Fluorolink composition E (HO(CH₂CH₂O)ₙCH₂CF₂O(CF₂CF₂O)ₚ(CF₂O)_{q}CF₂CH₂(OCH₂CH₂)ₙOH); Fluorolink composition C10 (HOOCCF₂P(CF₂CF₂O)ₚ(CF₂O)_{q}CF₂COOH); or Fluorolink composition T (HOCH₂CH(OH)CH₂OCH₂CF₂O(CF₂CF₂O)ₚ(CF₂O)_{q}CF₂CH₂OCH₂CH(OH)CH₂OH), for example. In these examples, p+q can be from 20 to 200, or from 40 to 180. Also, p/q can be from 0.25 to 5, or can be from 0.5 to 2. n can be from 1 to 6, or from 1 to 4, or from 1 to 2.

The aqueous inkjet ink composition 106 may also include any of a number of water soluble or water-miscible organic co-solvents, in addition to the water that is present. Any of a number of solvents can be used, but in accordance with examples of the present disclosure, certain organic co-solvents can be used to provide some of the benefits described herein, including properties related to jettability, decap performance, kogation, evaporation of water, viscosity, pH, surface tension, optical density, gamut, durability, print quality, etc. The water-soluble organic co-solvent system total concentration can range from about 5 wt % to about 50 wt %, or from about 10 wt % to about 40 wt %. An individual organic co-solvent alone can be typically present at from about 0.1 wt % to about 40 wt % of the inkjet ink composition. This being said, the solvents may be present in the inkjet ink composition at any concentration that is effective for use.

Example organic co-solvents that can be used include triethylene glycol, 2-pyrrolidinone, Dantocol [di(2-hydroxyethyl)-5, 5-dimethylhydantoin] or other cyclic amides. Other example co-solvents for use may include aliphatic alcohols, aromatic alcohols, diols, triols, glycol ethers, poly(glycol) ethers, lactams, formamides, acetamides, long chain alcohols, ethylene glycol, propylene glycol, diethylene glycols, triethylene glycols, glycerine, dipropylene glycols, glycol butyl ethers, polyethylene glycols, polypropylene glycols, amides, ethers, carboxylic acids, esters, organosulfides, organosulfoxides, sulfones, alcohol derivatives, carbitol, butyl carbitol, cellosolve, ether derivatives, amino alcohols, and ketones. For example, co-solvents can include primary aliphatic alcohols of 30 carbons or less, primary aromatic alcohols of 30 carbons or less, secondary aliphatic alcohols of 30 carbons or less, secondary aromatic alcohols of 30 carbons or less, 1,2-diols of 30 carbons or less, 1,3-diols of 30 carbons or less, 1,5-diols of 30 carbons or less, ethylene glycol alkyl ethers, propylene glycol alkyl ethers, poly(ethylene glycol) alkyl ethers, higher homologs of poly(ethylene glycol) alkyl ethers, poly(propylene glycol) alkyl ethers, higher homologs of poly(propylene glycol) alkyl ethers, lactams, substituted formamides, unsubstituted formamides, substituted acetamides, and unsubstituted acetamides. Specific examples of certain co-solvents that may likewise be used include, but are not limited to, 1,5-pentanediol, Liponic ethoxylated glycerol 1 (EG-1), Liponic ethoxylated glycerol 7 (EG-7), 2-methyl-2,4-pentanediol, 2-methyl-1,3-propanediol, 2-ethyl-2-hydroxymethyl-1,3-propanediol, diethylene glycol, 3-methoxybutanol, propylene glycol monobutyl ether, 1,3-dimethyl-2-imidazolidinone, and derivatives thereof.

Other additives that may be included include biocide to inhibit growth of undesirable microorganisms. Several non-limiting examples of suitable biocides include benzoate salts, sorbate salts, and commercial products such from the family Acticide®, Ucarcide®, Vancide®, Proxel® GXL, Kordex® MLX, etc. Typically, biocides, if present, are included at less than about 5 wt % of the inkjet ink composition and often from about 0.05 wt % to about 2 wt %. Other additives that may be present in the inkjet ink composition may include any of a number of other ingredients used in inkjet ink compositions, such as viscosity modifier, latex polymer, chelating agent, pH adjuster, buffer, or the like.

The aqueous inkjet ink composition(s) 106, after application to the primer composition (which was previously applied to the nail and to some surrounding skin), can then be covered in part over the nail, but not the surrounding skin, using a clear coat composition 108. The clear coat composition may only be applied to the aqueous inkjet ink composition 106 that is over the nail 102 and not applied to the aqueous inkjet ink composition 106 that is over the skin surrounding the nail. The clear coat composition may be applied using an analog applicator. The clear coat composition may be a composition that includes a water-insoluble polymer. The clear coat composition may be any suitable clear coat used in nail art applications. In one example, the clear coat composition can be composed of basic clear nail polish that is solvent based and can include many ingredients. The clear coat composition can include nitrocellulose dissolved in butyl acetate or ethyl acetate. By way of specific example, the clear coat composition may include from 8 wt % to 20 wt % of a nitrocellulose film former dissolved in about 50 wt % to 75 wt % or from 60 wt % to 70 wt % of solvent vehicle including a mixture of solvents such as butyl acetate, ethyl acetate, toluene, isopropyl alcohol (or another C1-C4 lower alkyl alcohol), etc. Other ingredients can include a resin, e.g., shellac or acrylic polymer, to enhance the durability of the clear coat composition as well as a plasticizer, e.g., camphor or dibutyl phthalate, to enhance the flexibility of the clear coat composition. Thickener may be included to enhance the viscosity so that the clear coat composition is not runny on application, for example. Since this is a clear coat composition, typically no colorant, such as pigment, is included, but small amounts may be included provided the clear coat composition remains transparent or translucent to the ink composition printed beneath the clear coat composition. Additives that provide sparkle, pearlescent appearance, etc., can be included in some examples. This type of clear coat composition is similar to an off-the-shelf clear nail polish lacquer commercially available from OPI (USA) or Revlon (USA).

In one example, as an alternative to a solvent based nail polish, the clear coat composition 108 may be a gel polish that is used as a topcoat. The gel coat may be cured using ultraviolet (UV) light. The UV light may be produced using light emitting diodes (LEDs). The clear coat composition should be sufficiently dried for solvent based nail polish or sufficiently cured for gel polish before removing excess aqueous inkjet ink composition 106 that was printed over the skin surrounding the nail 102. The gloss level of the final nail art can by adjusted selecting the clear coat composition with different levels of gloss. In one example, the clear coat composition can be removed using a solvent appropriate for the type of clear coat composition selected. After the solvent has been applied, any remaining layers can be removed by washing with mild soap and water.

FIG. 1B depicts cross sections of layers 150 formed from the fluid set for nail printing. The layers 150 include the layers 100 of FIG. 1A with the additional layer of the clear coat composition, as an undercoat composition 110. This undercoat composition may be the same clear coat composition shown at 108 or may be a different composition that is also clear or may in some examples not be clear (since it is applied as an undercoating) prior to application of the primer composition 104. The undercoat composition may be deposited only over the nail 102 and is not deposited over the skin surrounding the nail. The undercoat composition may be applied using an analog applicator. The purpose of the undercoat composition may be to protect the nail from being stained by the aqueous inkjet ink composition 106. The undercoat composition can be dried or cured before the deposition of the primer composition.

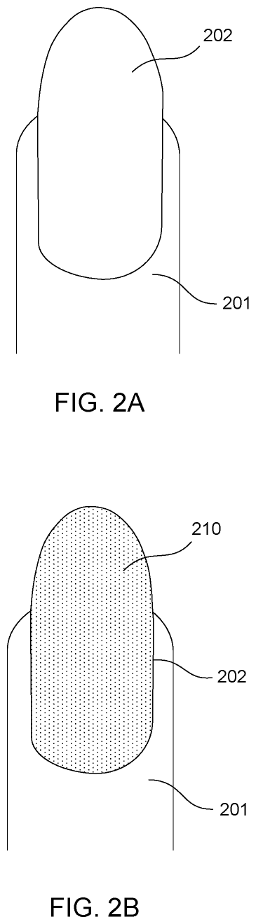

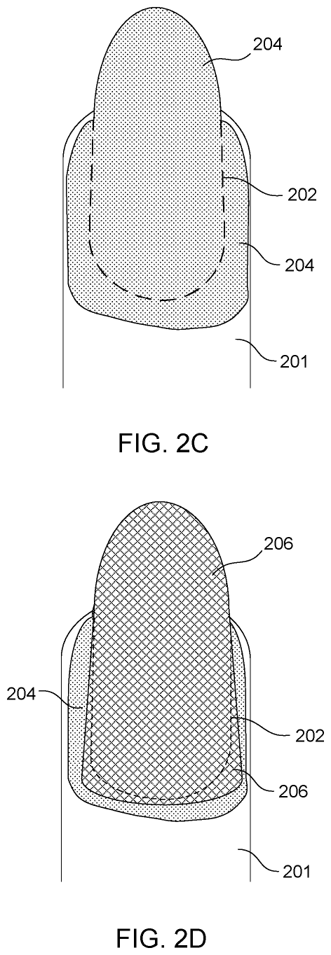

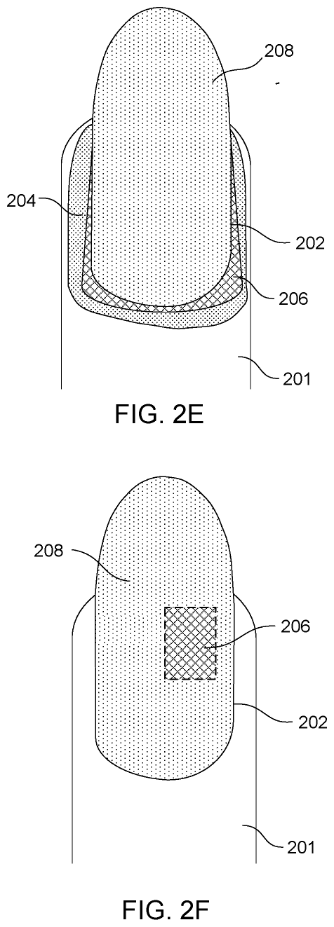

Turning now to FIGS. 2A-2F, a plan view graphically and schematically illustrating an example method of nail printing is shown. It should be appreciated that the fluid sets and compositions employed in FIGS. 2A-2F can be the same as the fluid sets and compositions described in FIGS. 1A-1B, for example. More specifically, FIG. 2A depicts a finger 201 and nail 202 of a user without any of the compositions of the fluid sets applied thereto.

FIG. 2B illustrates a subject's finger 101 and an undercoat composition 210 applied to the nail 202. The undercoat composition may be deposited over the nail using an analog applicator, but in this instance, not over the skin of the finger 201 surrounding the nail. The undercoat composition may be deposited to protect the nail from being stained by the composition. It should be appreciated that the undercoat composition is an optional layer and may or may not be deposited in various examples herein. Furthermore, the undercoating composition may be similar in composition or the same composition as the clear coat composition (not shown in this FIG.) that may be applied after the ink composition (also not shown in this FIG.).

FIG. 2C depicts a primer composition 204 deposited over the nail 202 and over skin on the finger 201 adjacent to the nail. If an undercoat composition, such as that shown at 210 in FIG. 2B, is used, the primer composition may be applied after the undercoat composition is sufficiently dry to receive the primer composition thereon with good adhesion thereto. As shown, the primer composition is deposited over a margin of skin surrounding a border of the nail. The border is depicted by the dotted line in FIG. 2C. The primer composition can be formulated to receive a subsequently applied inkjet ink composition, as well as to protect the immediately adjacent skin from being stained due to overprinting that may occur when the inkjet ink composition is applied to the nail. It should be appreciated that any size margin of skin surrounding the nail may be covered with the primer composition, as the primer composition can be formulated to be readily washed from the skin with water, and in some instances, a mild soap and/or solvent in addition to the water.

FIG. 2D depicts an aqueous inkjet ink composition 206 that has been deposited over the primer composition 204, both over the nail 202 and over an adjacent margin of skin beyond the border of the nail. The aqueous inkjet ink composition may be applied after the primer composition dries sufficiently on the skin and nail regions so that the primer composition may act to receive the inkjet ink composition with good image quality. In some examples, the aqueous inkjet ink composition(s) may be deposited over the full surface of the nail that is covered by the primer composition, but only over a portion of the skin that is covered by the primer composition.

FIG. 2E depicts a clear coat composition 208 deposited over the aqueous inkjet ink composition 206, which is over the primer composition 204 and the nail 202. The clear coat 218 is deposited over the nail, but not over the skin along the region of the finger overprinted with the primer composition. Thus, once the clear coat composition dries, the primer composition and the ink composition applied over the skin, but which do not have over coat composition applied thereto over the nail, may be removed by simple washing, including with water and in some instances, a mild soap. Soaps that contain organic oils (e.g. Dr Bronner's Castile Soap) may be avoided in some instances to prevent a softening of the clear coat composition. As an alternative to soap and water, the excess areas of the primer composition and the aqueous inkjet ink composition can be removed by carefully peeling off from the skin by using a rolling motion parallel to the cuticle line of the nail.

FIG. 2F depicts the finger 201 and the nail 202 after excess areas of the primer composition (not shown) and the aqueous inkjet ink composition (shown at 206 within a box having dashed lines to indicate that the ink composition layer is visible through the clear coat composition 208) have been removed from the surrounding skin, but where these layers have not been removed from over the nail. The excess areas of the primer composition and the aqueous inkjet ink composition can thus be removed when the clear coat has dried or cured sufficiently, protecting the nail art applied to the nail, while not protecting the primer composition and aqueous ink composition applied to the skin at the margin of skin adjacent to the nail during printing.

Thus, the present technology can provide ease of use and application for home consumers as well as for professional nail artists. The primer composition can provide an easy to remove water-soluble coating onto which the art is printed so, if a printing mistake occurs, it can be washed off and reapplied for reprint. Once the clear coat composition or topcoat is applied and dried, the primer composition and ink composition applied thereto becomes durable, but skin areas where the clear coat composition has not been applied, e.g., surrounding margins of skin, the primer coating and aqueous inkjet ink composition is able to be easily removed with water, soap, and or peeling from the skin. The process also may provide for the use of solvent-based polish for digital nail art printing which is more widely used and much easier to remove than LED-cured, e.g., UV-LED cured, Gel Polish used in prior nail art application processes. The present technology enables the use of lower cost digital printing systems. The FPC is compatible with most inkjet printers that use water-based inks which provide opportunity for broad usage. However, because of the nature of the fluid set materials and how they may be applied as described herein, these fluid sets, systems, and methods can be implemented in some examples without the use of a camera vision or scanning system component that is sometimes used to locate the position of the fingernail before printing. Imprecise finger placement may still result in a good result, as the printing process considers overprinting on the nail region of the finger.

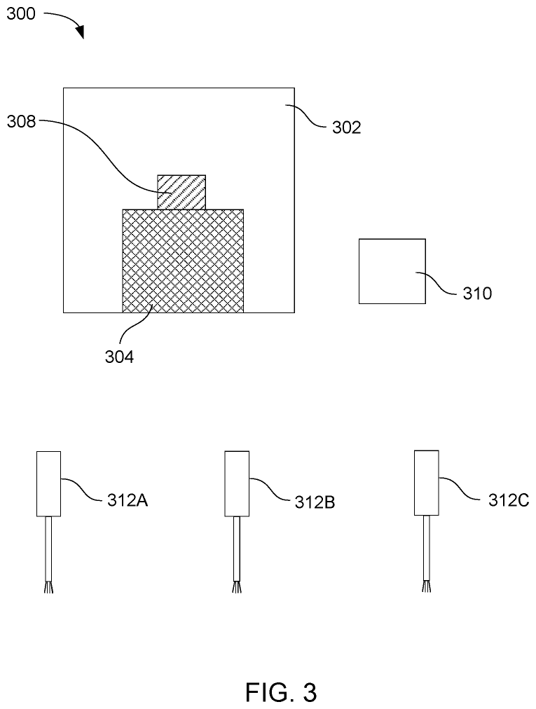

FIG. 3 depicts a system 300 for printing on a nail. The system can include two or more analog applicators, shown at 312A-312C, e.g., brushes, rollers, knives, spatulas, sponges, foams, etc., for applying an analog fluid to a nail, such as the undercoat composition (if used), the primer composition, and/or the clear coat composition. The other type of applicator shown in FIG. 3 is an inkjet printer 302, which can be designed to deposit an aqueous inkjet ink composition to a nail. Current brands of printers that may be used to apply inks to nails included those available from O′2 Nails, Tuoshi, Lexmark, Funai, or other similar manufactures that manufacture inkjet direct-to-nail printers. These can be adapted for use with the analog fluids of the fluid sets described herein, for example. Likewise, the HP, Inc. Remix or B-side printers may also be used with a guide tray such as a digit (finger or toe) positioner 310. As overprinting on the skin surrounding the nail is part of the presently disclosed method, the positioning of the finger can be much less precise than other nail printing systems that do not tolerate printing on the skin of the finger or toe, for example.

The printer 302 may include an opening 304 designed for inserting a finger (or toe) into the printer. Once the finger is inserted into the opening, the aqueous inkjet ink composition may be deposited over the nail and finger using an inkjet printhead 308. A digit positioner 310 may be used in conjunction with the printer to guide the finger or toe of the user into the opening. The digit positioner may be in the form of a jig or a guide that assists in positioning the finger(s) or toe(s) at the correct location for application of the ink composition to the primed nail and surrounding skin. Due to the nature of how the fluid set compositions are applied as described previously, more precise vision or scanning systems may or may not be used, and both such systems can provided acceptable results. In other words, the present technology intends on allowing the overprinting of the aqueous ink composition onto primer composition of surrounding skin (in addition to the nail) to provide full nail coverage and easily removable ink composition from the surrounding skin.

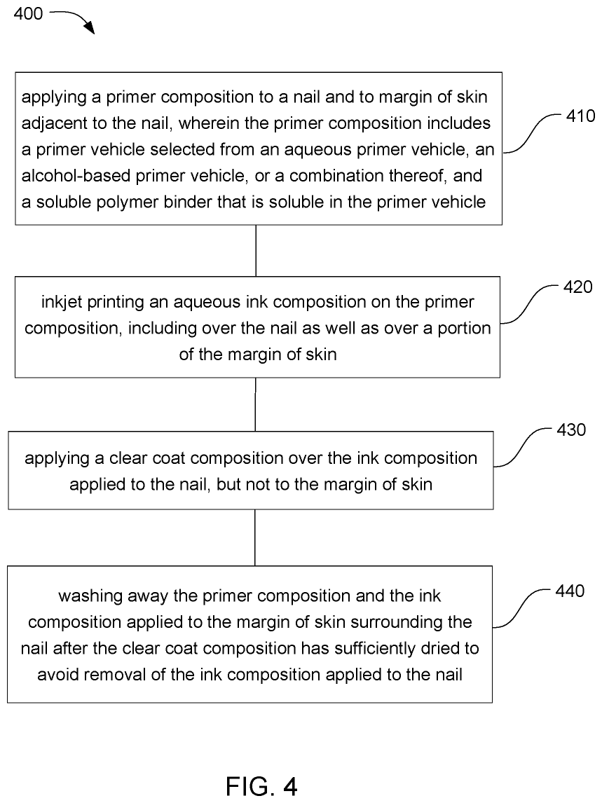

FIG. 4 is a flowchart illustrating an example method 400 of printing on a nail. The method includes applying 410 a primer composition to a nail and to a margin of skin adjacent to the nail, wherein the primer composition includes: a primer vehicle selected from an aqueous primer vehicle, an alcohol-based primer vehicle, or a combination thereof, and a soluble polymer binder that is soluble in the primer vehicle. The method further includes inkjet printing 420 an aqueous ink composition on the primer composition, including over the nail as well as over a portion of the margin of skin. The method further includes applying 430 a clear coat composition over the ink composition applied to the nail, but not to the margin of skin. The method further includes washing 440 away the primer composition and the ink composition applied to the margin of skin surrounding the nail after the clear coat composition has sufficiently dried to avoid removal of the ink composition applied to the nail.

It is noted that, as used in this specification and the appended claims, the singular forms “a,” “an,” and “the” include plural referents unless the content clearly dictates otherwise.

As used herein, the term “about” is used to provide flexibility to a numerical range endpoint by providing that a given value may be “a little above” or “a little below” the endpoint. The degree of flexibility of this term can be dictated by the particular variable and would be within the knowledge of those skilled in the art to determine based on experience and the associated description herein.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, dimensions, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a weight ratio range of about 1 wt % to about 20 wt % should be interpreted to include not only the explicitly recited limits of about 1 wt % and about 20 wt %, but also to include individual weights such as 2 wt %, 11 wt %, 14 wt %, and sub-ranges such as 10 wt % to 20 wt %, 5 wt % to 15 wt %, etc.

### EXAMPLES

The following examples illustrate the technology of the present disclosure. However, it is to be understood that the following is only exemplary or illustrative of the application of the principles of the presented formulations and methods. Numerous modifications and alternative methods may be devised by those skilled in the art without departing from the spirit and scope of the present disclosure. The appended claims are intended to cover such modifications and arrangements. Thus, while the technology has been described above with particularity, the following provide further detail in connection with what are presently deemed to be the acceptable examples.

### Example 1—Primer Composition 1 with Multiple Pigments

A primer composition is prepared that includes 81.46 wt % deionized water, 12.26 wt % cationic water-soluble polyvinyl alcohol (PVOH) binder (GohsenX K-434), 6.1 wt % TiO₂ pigment dispersed with Disperbyk® 2012 (Ti-Pure R706), and 0.04 wt % Boehmite alumina (Disperal® HP-14).

### Example 2—Primer Composition 2 with Multiple Soluble Polymer Binders

A primer composition is prepared that includes 73.12 wt % of deionized water, 15 wt % isopropanol, 3 wt % high molecular weight polyvinyl alcohol polymer binder (Poval 235), 3 wt % low molecular weight polyvinyl alcohol polymer binder (Poval 25-98), 5.1 wt % TiO₂ pigment dispersed with Disperbyk® 2012 (Ti-Pure R706), and 0.04 wt % Boehmite alumina (Disperal® HP-14).

### Example 3—Application of Fluid Sets to Fingernails

Primer Compositions 1 and 2 are applied to a fingernail as well as to the surrounding skin. The white pigment provided good opacity for providing a white palate for subsequent application of an inkjet ink composition. The crystalline structure of the boehmite alumina was also noted assisting with reducing agglomeration or settling of the titanium dioxide pigment, and when settling did occur, the pigment could be easily stirred back to a homogenous dispersion without clumps in preparation for analog application to the nail and surrounding skin.

Though both Primer Compositions 1 and 2 provided acceptable coatings preceding the application of an ink composition thereto, the presence of the isopropyl alcohol in Primer Composition 2 provided faster dry time than the formulation of Primer Composition 1. For example, the isopropyl alcohol has lower surface tension and faster evaporation rate than water, so it seemed to aid in wetting during application and provided faster drying. Furthermore, where there might otherwise be bubbles present in the primer composition, isopropyl alcohol can act or assist with breaking bubbles to provide a smoother coating. Isopropanol can also aid in the prevention of microbial growth in fluid. Furthermore, the combination of high and low molecular weight polyvinyl alcohol in Primer Composition 2 provided the ability to fine tune the fluid rheology/viscosity for wet application and durability/washability of the dry coating. The higher molecular weight polyvinyl alcohol provided enhanced durability that was less easily washed from the skin, whereas the lower molecular weight polyvinyl alcohol provided easy washability. A balance of good durability and good washability can be achieved by modifying the ratio of the two polyvinyl alcohol.

Primer Compositions 1 and 2 are paired with an aqueous anionic dye-based inkjet ink composition, for example, that can be digitally ejected onto the primer composition after drying with good image quality. The ink compositions evaluated with these two primer compositions were water-based inks with anionic dye, and had a wet density of about 1. The anionic dye in these example is chemically interactive with the cationic PVOH of Primer Composition 1, which assisted with keeping the anionic dye at a surface of the primer composition coated on the nail. Keeping the anionic dye toward the top of the primer composition can provide good color properties, as the white pigment of the primer composition could otherwise mask some of the dye if penetrated too deeply into the primer composition. Thus, the aqueous ink composition provided acceptable image and color quality with this particular primer composition. Though Primer Composition 2 did not include a cationic soluble polymer binder, acceptable image quality and reasonable color gamut could be achieved with some of the durability and washability properties previously described.

With respect to nails coated with either Primer Compositions 1 or 2, and further digitally printed with the ink composition described in this example, the fluid sets of this specific example further includes a clear coat composition that can be applied using a nail polish brush. By way of example, the clear coat composition of this example includes 12 wt % to 15 wt % of a nitrocellulose film former dissolved in about 60 wt % to 70 wt % solvent vehicle including a mixture of butyl acetate, ethyl acetate, toluene, and isopropyl alcohol. Other ingredients include shellac resin and camphor plasticizer to enhance the strength and flexibility of the lacquer, respectively. No colorant is included in the clear coat composition. This clear coat composition is similar to any of a number of off-the-shelf clear nail polish lacquer commercially available from OPI (USA) or Revlon (USA). By applying the clear coat composition to the nail over the respective printed aqueous inkjet ink compositions, but not to the surrounding skin that includes primer composition and ink composition applied thereto, the image printed on the nail becomes durable and is not removed when the finger is washed with water and hand soap.

While the present technology has been described with reference to certain examples, those skilled in the art will appreciate that various modifications, changes, omissions, and substitutions can be made without departing from the spirit of the disclosure. It is intended, therefore, that the disclosure be limited only by the scope of the following claims.

What is claimed is:

1. A fluid set for nail printing, comprising:
a primer composition, including:
from 40 wt % to 90 wt % primer vehicle selected from an aqueous primer vehicle, an alcohol-based primer vehicle, or a combination thereof,
from 5 wt % to 50 wt % a soluble polymer binder that is soluble in the primer vehicle;
an aqueous inkjet ink composition including an ink vehicle and a colorant; and
a clear coat composition including a water-insoluble polymer.

2. The fluid set of claim 1, wherein the primer composition further includes from 0.1 wt % to 18 wt % pigment including white metal oxide pigment.

3. The fluid set of claim 1, wherein the soluble polymer binder is a cationic water-soluble polymer.

4. The fluid set of claim 1, wherein the soluble polymer binder includes a polyvinyl alcohol, a polyacrylic acid, a polyvinyl pyrrolidone, or a mixture thereof.

5. The fluid set of claim 1, wherein the colorant includes an anionic dye interactive with the soluble polymer binder.

6. The fluid set of claim 1, wherein the primer composition further comprises a latex polymer including a polyvinyl acetate polymer, a polyvinyl butyral polymer, a hydrophobic-modified ethoxylated urethane polymer, a cellulosic polymer, or a combination thereof.

7. The fluid set of claim 1, wherein the primer vehicle comprises water and an organic co-solvent selected from methanol, ethanol, isopropyl alcohol, acetone, or a combination thereof.

8. The fluid set of claim 1, wherein the clear coat composition is an ultraviolet curable gel, or the clear coat composition comprises nitrocellulose polymer.

9. A method of nail printing, comprising:
applying a primer composition to a nail and to margin of skin adjacent to the nail, wherein the primer composition includes:
a primer vehicle selected from an aqueous primer vehicle, an alcohol-based primer vehicle, or a combination thereof, and
a soluble polymer binder that is soluble in the primer vehicle;
inkjet printing an aqueous ink composition on the primer composition, including over the nail as well as over a portion of the margin of skin;
applying a clear coat composition over the ink composition applied to the nail, but not to the margin of skin; and
washing away the primer composition and the ink composition applied to the margin of skin surrounding the nail after the clear coat composition has sufficiently dried to avoid removal of the ink composition applied to the nail.

10. The method of claim 9, further comprising applying the clear coat composition to the nail prior to application of the primer composition to protect the nail from staining.

11. The method of claim 9, wherein applying the primer composition and applying the clear coat composition are both applied independently using an analog applicator.

12. The method of claim 9, wherein the soluble polymer binder of the primer composition swells and entraps the colorant when the aqueous inkjet ink composition is applied to the primer composition on the nail and on the portion of the margin of skin.

13. The method of claim 9, wherein the soluble polymer binder of the primer composition crashes with the colorant when the aqueous inkjet ink composition is applied to the primer composition on the nail and on the portion of the margin of skin.

14. A system for nail printing, comprising:
a primer composition, including a primer vehicle selected from an aqueous primer vehicle, an alcohol-based primer vehicle, or a combination thereof, and a soluble polymer binder that is soluble in the primer vehicle;
a first analog applicator to apply the primer composition to a nail and a margin of skin surrounding the nail;
an aqueous inkjet ink composition including an ink vehicle and a colorant;
a printer, including an inkjet printhead directed or directable to print the aqueous inkjet ink composition on the nail and a portion of the margin of skin when a digit is positioned to receive the aqueous inkjet ink composition;
a clear coat composition including a water-insoluble polymer; and
a second analog applicator to apply the clear coat composition on the nail but not to the margin of skin.

15. The system of claim 14, wherein the printer further includes a digit positioner to assist with positioning a nail at a specified location associated with the printer to receive the aqueous inkjet ink composition at the nail and the portion of the margin of skin.
